(19) United States
(12) Patent Application Publication
(10) Pub. No.: US 2025/0341436 A1
(43) Pub. Date: Nov. 6, 2025

(54) PRESSURE SENSOR DEVICE, IN PARTICULAR FOR GASEOUS FLUIDS

(71) Applicant: ELTEK S.p.A., Casale Monferrato (Alessandria) (IT)

(72) Inventors: Angelo ALBONICO, Casale Monferrato (Alessandria) (IT); Simona ANSALDI, Casale Monferrato (Alessandria) (IT); Mauro ZORZETTO, Casale Monferrato (Alessandria) (IT)

(21) Appl. No.: 18/879,907

(22) PCT Filed: Jun. 30, 2023
(86) PCT No.: PCT/IB2023/056826

§ 371 Date: Dec. 30, 2024

(30) Foreign Application Priority Data
Jul. 5, 2022 (IT) 102022000014233

(51) Int. Cl. G01L 9/00; G01L 19/14

(52) U.S. Cl. CPC G01L 9/0051; G01L 9/008; G01L 19/14

(57) ABSTRACT

A pressure sensor device has a pressure-sensitive element (3), including a detection membrane, and a control circuit (30), including a circuit support (30a) and electrical connecting elements (3e), the pressure-sensitive element (3) being mounted on a supporting body in such a way that a substantial portion of the detection membrane is exposed to a fluid, wherein the supporting body has an engaging part (4) comprising a distal end portion, and the circuit support (30a) is associated to a positioning body (20), which is on the pressure-sensitive element (3), with the electrical connecting elements (3e) which constrain the circuit support (30a) to the pressure sensitive element (3), with the positioning body (20) at least partially set therebetween, to form a detection unit (10), detection unit (10) being fixed to the distal end portion of the engaging part (4) by means of a fixing element (6).

### FIELD OF INVENTION

The present invention refers to pressure sensor devices and has been developed with particular reference to sensor devices intended for detection of the pressure of fluids subject to at least partial icing, in particular gaseous fluids, such as gaseous fluids containing moisture or water vapor or a suspension susceptible to freezing.

### PRIOR ART

Pressure sensor devices for fluid media are widely known. Such devices typically include a pressure-sensitive element having a substrate that defines or has an elastically deformable detection membrane associated thereto. At one side of the membrane not exposed to the fluid there are associated elements for detecting the deformation or bending of the membrane itself, typically capacitive, resistive or piezoresistive elements, in order to obtain information representative of the extent of deformation or bending, which is in turn representative of the value of the pressure of the fluid to which the membrane is exposed.

Miniature sensitive elements formed with semiconductor material, typically starting from a silicon die, are known but generally-for applications where greater robustness is required-the sensitive elements are larger and are generally formed in ceramic material, for example alumina, or in metallic material, for example stainless steel.

The pressure sensor devices that mount these sensitive elements typically comprise a housing body configured to obtain an electrical connection and a hydraulic connection, within which the sensitive element and any associated control electronics are mounted. For electrical connection purposes, the casing body typically defines a connector body with electrical connection terminals. For the purposes of hydraulic connection, the casing body defines a plastic or metal port, configured for interfacing with the circuit in which the fluid whose pressure must be measured is located. The port generally has a tubular shape and therefore defines a channel, through which the fluid can reach a chamber defined inside the casing body, which is delimited in part by the membrane of the sensitive element, which can thus be reached by the same fluid.

The inlet channel and the detection chamber may be subject to fluid accumulation, even after the interruption of the circulation of the fluid in the corresponding circuit. These possible accumulations of liquid are potentially risky, in relation to the reliability of operation and the integrity of the sensitive element, if the sensor device is operating in conditions of low ambient temperature. In such circumstances, in fact, the liquid residues can freeze, thus increasing in volume and exerting considerable mechanical stress on the sensitive element.

To overcome this problem, solutions have been proposed in which, inside the fluid inlet channel and/or in the detection chamber, a protection element formed having an elastically compressible material is arranged. In these solutions, the increase in volume given by the icing of the fluid residues is compensated by the decrease in the volume of the protection element. These solutions are relatively simple, but the related sensor devices have the disadvantage of requiring relatively long waiting times, in order that the devices themselves can return to normal operation (in essence, the device is not able to measure the pressure in the circuit except after the complete thawing of the fluid). This drawback is particularly felt in cases where the fluid subject to pressure detection is or includes a gas that has a moisture or water vapour content, or a fluid that can freeze.

A typical example in this sense is that of fuel cells, where hydrogen and air, present respectively on the anode side and on the cathode side, can have a certain moisture content. Even in these cases, moisture present in the gas can accumulate in the inlet channel and in the detection chamber, even for long times, particularly when the operating temperatures drop below the dew point. In these cases, in the case of temperatures that then drop below the freezing point, the trapped moisture can freeze and block or alter the operation of the detection membrane, preventing the sensor device from correctly measuring the pressure of the fluid inside the channel where the fluid flows.

In order to overcome the drawbacks related to the possible icing of fluid or moisture residues, solutions have also been proposed in which the inlet channel is filled with an incompressible fluid. In these solutions, the pressure of the fluid subject to pressure measurement can then stress the incompressible fluid, which in turn transfers the stress to the sensing diaphragm. In this way, the sensor device has no duct or chamber within which the accumulation of liquid or moisture can occur, thus avoiding the aforementioned drawback. On the other hand, these solutions result in a complicated production process of the sensor device, and are therefore very expensive. A related drawback of these solutions is related to the impossibility of equipping the device also with means for detecting the temperature of the fluid, unless requiring significant complications in the realization of the device itself.

A simpler solution to the problem indicated is known from KR 20190059433 A, on which the preamble of claim 1 is based. In this solution, the pressure sensor device is designed in such a way that the detection membrane of the sensitive element is directly exposed to the fluid of a gas inside the duct in which the same gas circulates.

The annexed FIGS. 1 and 2 correspond to FIGS. 5 and 6 of the cited prior art document, respectively. In these figures, 700 designates a sensor body or cover, inside which a circuit support 400 is placed, bearing the control electronics of the device.

The underside of circuit support 400 have a substrate 200 directly associated thereto, and at the lower end of the substrate detection membrane 300 is fixed by means of a fixing material 220. The substrate 200 and the membrane 300 are made of ceramic material, and the fixing material 220 can be glass frit. The sensitive element consisting of the substrate 200 and the membrane 300 associated thereto is equipped with terminals or pins 500 for connection to the circuit support 400, to the latter there being also electrically connected terminals 710 mounted on the cover 700.

As visible in particular in FIG. 2, in the assembled condition, the sensitive element consisting of the substrate 200 and the membrane 300 protrudes below beyond the cover 700, to which it is fixed by means of the circuit support 400 and by a layer of epoxy resin 600.

In order to fix the substrate 200 and the corresponding circuit support 400 to the cover 700, and to ensure that the sensor is airtight with respect to the external environment, the epoxy resin 600 is injected at one end of the cover 700. To improve assembly, the substrate 200 has an upper annular throat 210, in which the resin 600 can hold. In such an assembled condition, the substrate 200 and the membrane 300 protrude relative to cover 700. The substrate 200 also has a lower groove, which obtains a seat for an annular gasket 220, intended to obtain a seal with respect to the surface of the radial passage in which the sensitive element 200-300 is inserted. As shown in particular in FIG. 2, in the operating condition, the sensitive element consisting of the substrate 200 and the membrane 300 is inserted into a radial passage of a duct 110 in which the gas flows, so that the membrane 300 is directly exposed to the gas.

As can be seen, therefore, in the assembled condition, the membrane 300 is directly exposed to the gas flowing into duct 110, eliminating or otherwise minimizing possible points of accumulation of moisture inevitably present in the same gas.

The type of construction envisaged in the prior mentioned art document is complicated and expensive, also in relation to the ways of mounting the device, which must be installed with its sensitive part directly inside a corresponding passage of the gas circulation duct. Furthermore, the fact that a radial seal is obtained directly between the substrate 200 of the sensitive part and the passage of the duct determines risks of high friction and/or torsion during insertion, with consequent abnormal mechanical stresses, which could also derive from operating conditions (for example vibrations), with consequent possible damage to the sensitive part and/or the circuit support. This risk is partly increased also by the fact that the sensitive element is connected to the circuit support through thin terminals, and the fixing is carried out only by means of a thin layer of epoxy resin.

Aim and summary of the invention

In its general terms, the present invention aims to create a pressure sensor device, particularly intended for use in combination with gaseous fluids, the construction of which is simple and economical, which is easy to install and highly reliable. This and other aims, which will become clearer later, are achieved according to the present invention by a pressure sensor device having the characteristics of the attached claims. The claims form an integral part of the technical teaching provided herein in connection with the invention.

### BRIEF DESCRIPTION OF THE DRAWINGS

Further aims, characteristics and advantages of this invention will be clear from the following detailed description, made with reference to the attached schematic drawings, provided purely as a non-limiting example, wherein:

FIGS. 1 and 2 are a reproduction of FIGS. 5 and 6, respectively, of the prior art technique represented by KR 20190059433 A;

FIGS. 3, 4 and 5 are schematic views, respectively in perspective, in section and in partial exploded view, of a pressure sensor device according to possible embodiments;

FIG. 6 is a partial and schematic view, partially exploded, of two components of the device of FIG. 5,

FIGS. 7 and 8 are schematic views, respectively in perspective and in partial exploded view, of a detection unit of a pressure sensor device according to possible embodiments, with a corresponding sealing element;

FIG. 9 is a schematic exploded view of a sensitive element of a pressure sensor device according to possible embodiments;

FIGS. 10 and 11 are schematic exploded views, from different angles, of a detection unit of the type shown in FIGS. 7 and 8;

FIGS. 12 and 13 are schematic perspective views of a positioning body belonging to a detection unit of the type shown in FIGS. 10 and 11;

FIG. 14 is a partially sectioned perspective view of a part of the device of FIGS. 3-5;

FIG. 15 is a detail on a larger scale than FIG. 4;

FIGS. 16 and 17 are two schematic sections meant to exemplify two possible configurations of use of a pressure sensor device according to possible embodiments of the invention;

FIG. 18 is a schematic perspective view similar to that of FIG. 3, relating to a possible variant embodiment;

FIG. 19 is a schematic perspective view similar to that of FIG. 3, relating to a pressure sensor device according to a further embodiment;

FIGS. 20 and 21 are views similar to those of FIGS. 14 and 15, relating to the embodiment of FIG. 19;

FIG. 22 is a schematic perspective view similar to that of FIG. 3, relating to a pressure sensor device according to a further embodiment;

FIGS. 23 and 24 are views similar to those of FIGS. 14 and 15, relating to the embodiment of FIG. 22;

FIG. 25 is a schematic perspective view of a pressure sensor device according to a further embodiment;

FIGS. 26 and 27 are views similar to those of FIGS. 14 and 15, relating to the embodiment of FIG. 25;

FIGS. 28 and 29 are schematic views, respectively in section and in partially sectioned perspective, of a sensitive element of a pressure sensor device according to further possible embodiments;

FIGS. 30 and 31 are schematic views, respectively in section and in partially sectioned perspective, of a sensitive element of a pressure sensor device according to further possible embodiments;

FIG. 32 is a partially sectioned and schematic perspective view of a sensitive element of a pressure sensor device according to further possible embodiments;

FIGS. 33, 34 and 35 are schematic sections meant to exemplify further possible embodiments of the invention;

FIGS. 36 and 37 show, through views similar to those of FIGS. 19 and 21, respectively, a possible variant embodiment;

FIG. 38 is an enlarged detail of FIG. 37;

FIGS. 39 and 40 show, through views similar to those of FIGS. 19 and 21, respectively, another possible variant embodiment;

FIG. 41 is an enlarged detail of FIG. 37;

FIG. 42 is a schematic perspective view of a detection unit of a pressure sensor device according to possible variant embodiments; and

FIG. 43 shows, through a view similar to that of FIG. 15, an assembled condition of the detection unit of FIG. 42.

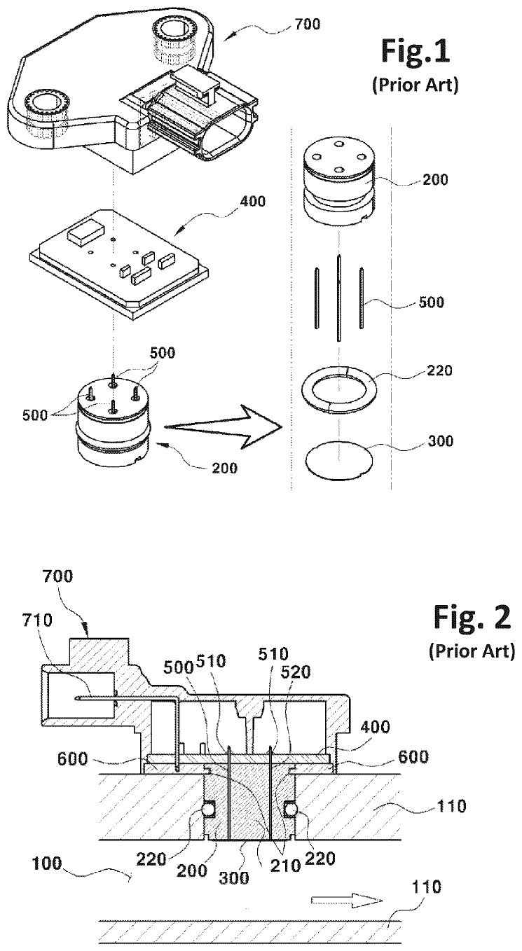

### DESCRIPTION OF PREFERRED EMBODIMENTS OF THE INVENTION

The reference to “an embodiment” in this description indicates that a particular configuration, structure, or characteristic described in relation to the embodiment is included in at least one embodiment. Thus, phrases such as “in one embodiment” and the like, possibly present in different places in this description, do not necessarily refer to the same embodiment. In addition, particular conformations, structures or characteristics described or illustrated can be combined in any appropriate way in one or more embodiments, even different from those depicted. The references used here are for convenience only and therefore do not define the scope of protection or the scope of the embodiments. Spatial references (such as “upper”, “lower”, “top”, “bottom”, etc.) as used herein are for convenience only and refer to the examples as shown in the figures. In the figures the interpenetration of some elements depicted (such as some sealing elements or some electrical contact elements) is intended to highlight the original shape of the elements themselves, before their elastic deformation following compression.

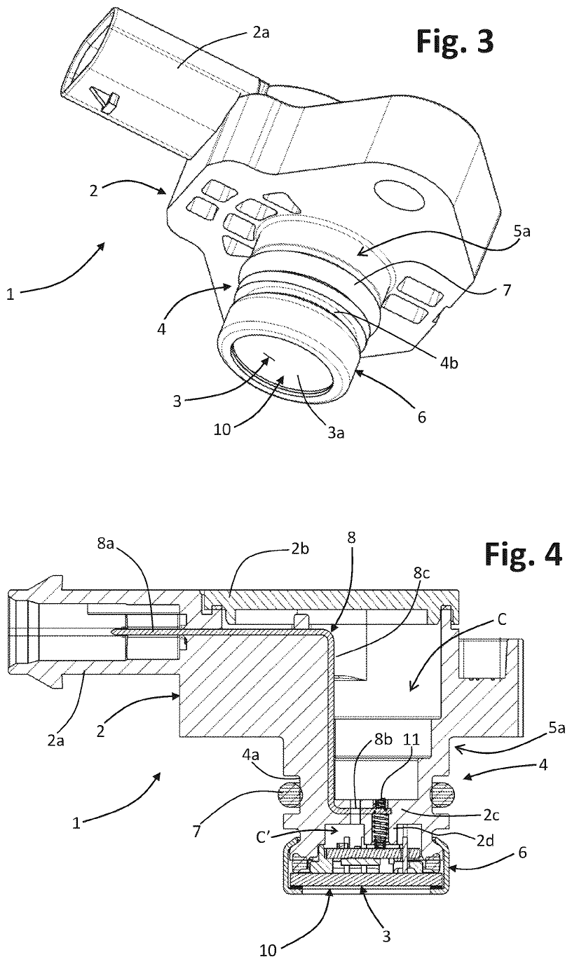

Referring initially to FIGS. 3-6, reference 1 designates as a whole a pressure sensor device according to possible embodiments, particularly for use in combination with fuel cells. The device 1 comprises a supporting body 2, to which a pressure detection arrangement is associated. For example, the supporting body 2 can be made of moulded plastic, although not excluding a metal material, or a combination of the materials indicated. The aforementioned detection arrangement includes a pressure-sensitive element 3, having an elastically deformable detection membrane 3a, and a circuit arrangement, described below. As can be seen, for example in FIG. 3, the sensitive element 3 is associated to the supporting body 2 in such a way that a substantial portion of the detection membrane 3a is directly exposed to the outside of the supporting body 2, to be reached by a fluid, as explained below. For this purpose, in various embodiments, the sensitive element 3 is associated to the body 2 so as to be located outside the body itself, although preferably protected by the body 2 or by a protective element applied thereto. In the following, suppose that the fluid in question is a gaseous fluid.

In various embodiments, the supporting body 2 has an engaging part 4, which is particularly configured for insertion into a passage of a duct for the fluid the pressure of which must be detected, as explained below. In the non-limiting example, the body 2 has an upper portion having larger section dimensions with respect to the engaging part 4, with the latter extending from said upper portion. However, in possible actuation variants, the body 2 could extend only axially (e.g., have a substantially cylindrical cross-section), in which case only the lower portion of that axially extended body obtains the engaging part 4.

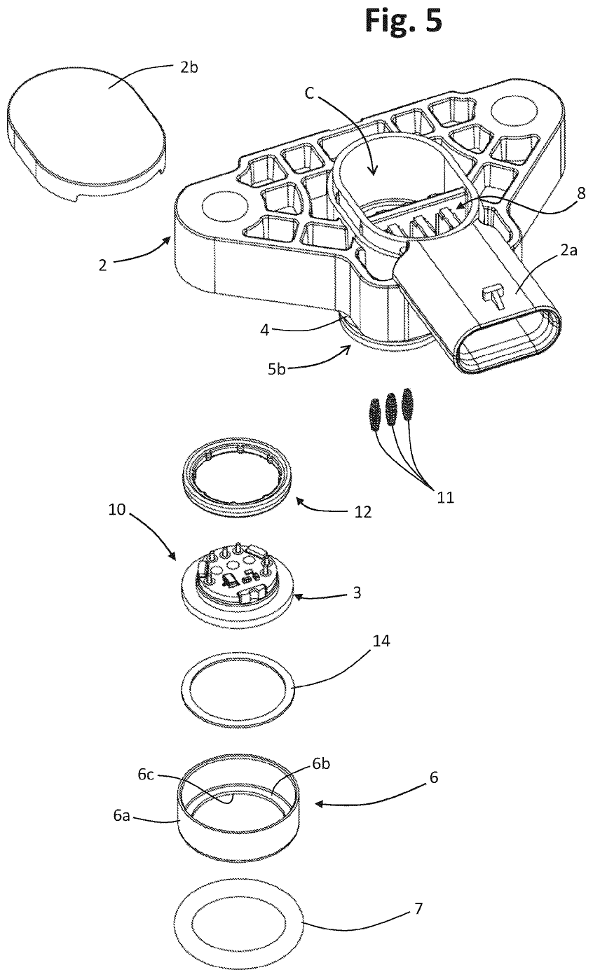

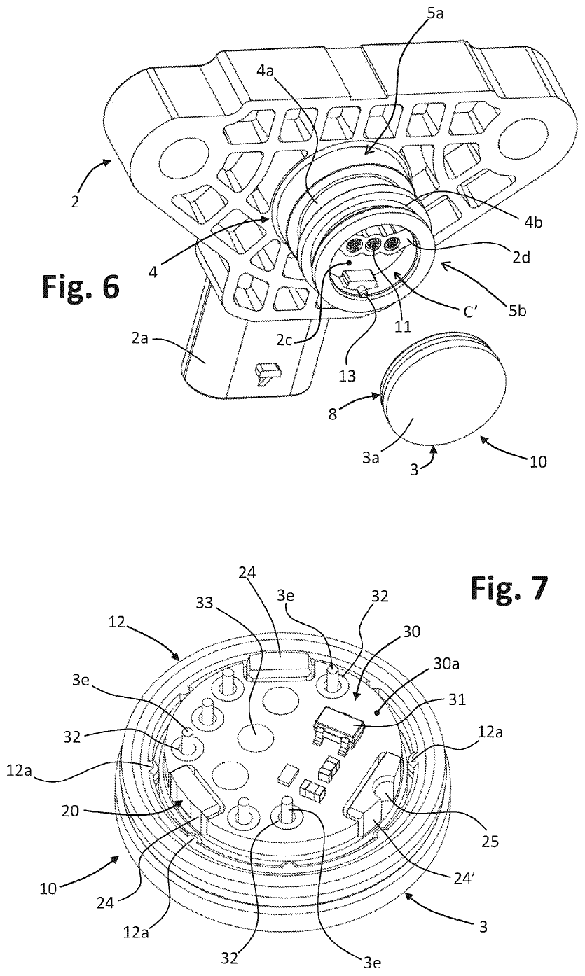

The engaging part 4, preferably substantially cylindrical, has a proximal end portion, designated by 5a for example in FIGS. 3-4, which is closer to the part of the body 2 that must remain outside the fluid duct, and a distal end portion, designated by 5b for example in FIGS. 5-6, which is farther from the part of the body 2 that must remain outside the fluid duct. The pressure-sensitive element 3 is constrained at the distal end portion 5b by at least one fixing element, such as the element designated by 6. In various embodiments, this fixing element performs functions of partial protection of the sensitive element 3. The engaging part 4 is preferably provided externally with sealing means: in the example, the part 4 defines for this purpose an intermediate seat 4a for the positioning of an elastomer sealing ring 7. The seat 4a is in a position intermediate to the proximal ends 5a and the distal ends 5ba of the engaging part 4.

The detection arrangement includes a plurality of electrical terminals for connection of the device 1, such as three terminals, one of which is indicated by 8 in FIG. 4. As can be seen in this figure, the terminals 8 have a proximal end portion 8a that protrudes within a tubular portion 2a of the body 2, in order to obtain a multipolar electrical connector. The distal end portion 8b of the terminals 8 extends within the body 2, preferably as far as the inside of the engaging part 4. In the example, the proximal and distal end portions of the terminals 8 are essentially flat and parallel, joined together by a straight intermediate portion 8c. The terminals 8 could still have a different shape and location than the case exemplified, without prejudice to their functions.

The body 2, when formed by plastic material, can be directly moulded over the terminals 8, and possibly define an internal cavity, indicated by C in FIGS. 4-5: in such a case, the body 2 may include a cover 2b for closing the cavity. The cavity C can serve to make the body 2 more lighter and/or be useful to keep the terminals 8 in place during the overmoulding phase of the body 2.

As will become clearer later, the sensitive element 3 is part of a detection unit, designated as a whole with 10 in the figures, which is mounted at the distal end portion 5b of the engaging part 4 of the body 2, said portion 5b being particularly configured for insertion into a passage of a duct for the fluid duct whose pressure must be detected. For this purpose, in various embodiments, this distal end portion 5b defines a housing designated by C′in FIG. 6, which is open downwards (referring to the figure), that is, towards the outside of the body 2, in which the aforementioned unit 10 is at least partially received.

From FIGS. 4 and 6 it can be seen that, in possible embodiments, the engaging part 4 has a transverse wall 2c which defines a bottom of the housing C′, at which are through seats are defined (not indicated), preferably axial through seats, for respective contact elements 11; for this purpose, the aforementioned seats are defined in the wall 2c, for example at a formation or thickening of this wall. In various embodiments, the contact elements 11 are electrically conductive elastic contact elements, which preferably do not require welding, such as compression contact elements, as explained below. In the depicted non-limiting example, the elements 11 are basically in the form of helical springs; alternatively, the contact elements 11 could have another shape, for example at least partly arcuate, such as a substantially “S” or “C” shaped.

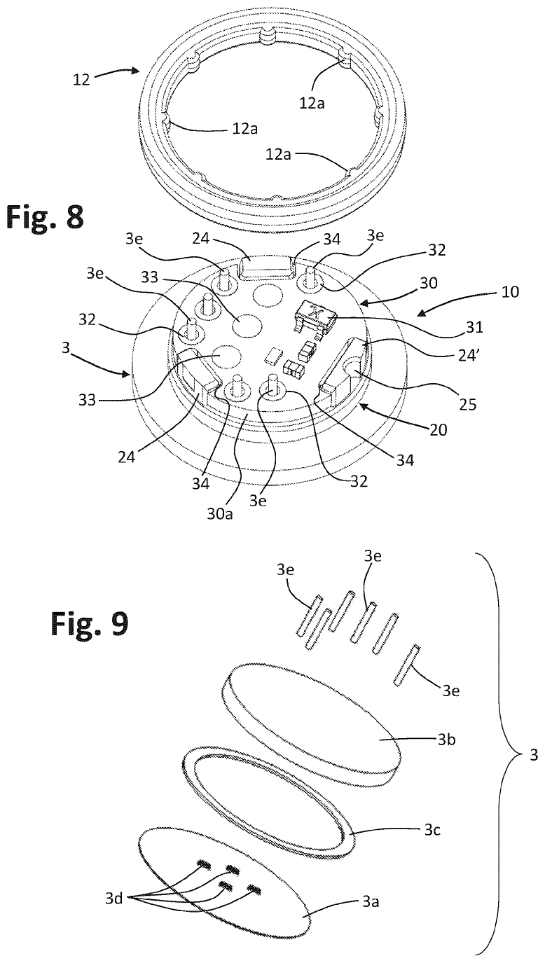

FIGS. 7 and 8 show a possible realization of the previously mentioned detection unit 10, with a corresponding annular sealing element 12.

The unit 10 comprises, in addition to the abovementioned sensitive element 3, a control circuit 30, which is part of a circuit arrangement of the device, this arrangement also including electrical connecting elements that electrically connect the sensitive element 3 to the control circuit 30. In various embodiments, unit the 10 also comprises a positioning body 20, preferably configured as a separate part both with respect to the circuit 30 and with respect to the sensitive element 3 (but it may be of a shape capable of being coupled or fixed to at least one of the control circuit 30 and the sensitive element 3).

The sealing element 12, which is preferably configured to achieve an axial seal, encircles at least partially the unit 10, particularly substantially at the positioning body 20, if the latter is present. In various embodiments, at the inner diameter of the sealing element 12 bosses or radial projections 12a (FIG. 8) are provided, which allow the element itself to be mounted on the unit 10 in a centered position and/or with slight elastic interference. The projections 12a might be absent, in which case the inner diameter of the element 12 would be such to enable mounting thereof on the unit 10 in a centered position and/or with slight elastic interference.

In FIG. 9 there is schematically represented in exploded view a possible realization of the sensitive element 3, which is preferably a non-miniaturized element (meaning that element 3 is not of the type obtained from a die in semiconductor material, such as silicon). In various embodiments, the element 3 comprises a substrate 3b, to which the membrane is attached by means of a suitable fixing material 3c. For example, if the membrane 3a and substrate 3b are made of ceramic material (e.g., alumina), the fixing material 3c can be glass frit or a glue.

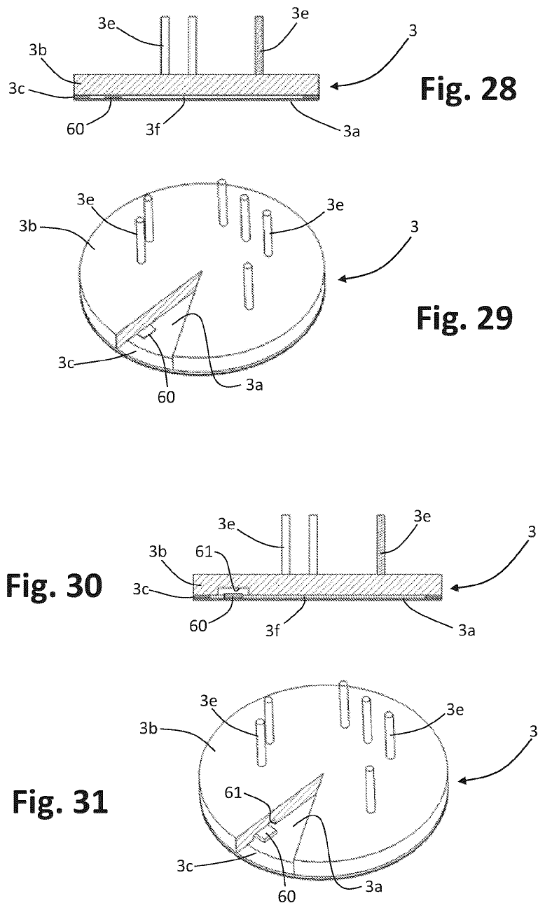

The material 3c is arranged in an annular configuration at a radially outermost area of the opposing faces of membrane and substrate, and has a thickness such that a chamber is defined between the membrane and the substrate (see reference 3f in FIGS. 28 and 30), or in any case a space sufficient to allow elastic bending of the membrane. Preferably, the material 3c achieves a hermetic seal between the membrane 3a and the substrate 3b.

The sensitive element 3 is provided with means for detecting the elastic deformation or bending of the membrane 3a. In various embodiments, on the inner side of the membrane 3a (i.e., its face facing the substrate 3b), sensitive elements 3d are arranged according to known technique, e.g., piezoelectric or resistive elements arranged in a bridge configuration (particularly a Wheatstone bridge). By means of electrically conductive tracks not represented, the detection elements 3d are connected in signal communication with connection terminals or pins 3e of the sensitive element 3, according to a technique known in itself; in the example, the pins 3e are fixed passing through corresponding holes defined in the substrate 3b, and are arranged at a radially outermost annular region of the upper face of the substrate 3b, so as not to hinder the deformation of the membrane 3a. In various preferential embodiments, the pins 3e obtains the connecting elements used to electrically connect and mechanically constrain the sensitive element 3 to the circuit 30, with the positioning body 20 set therebetween.

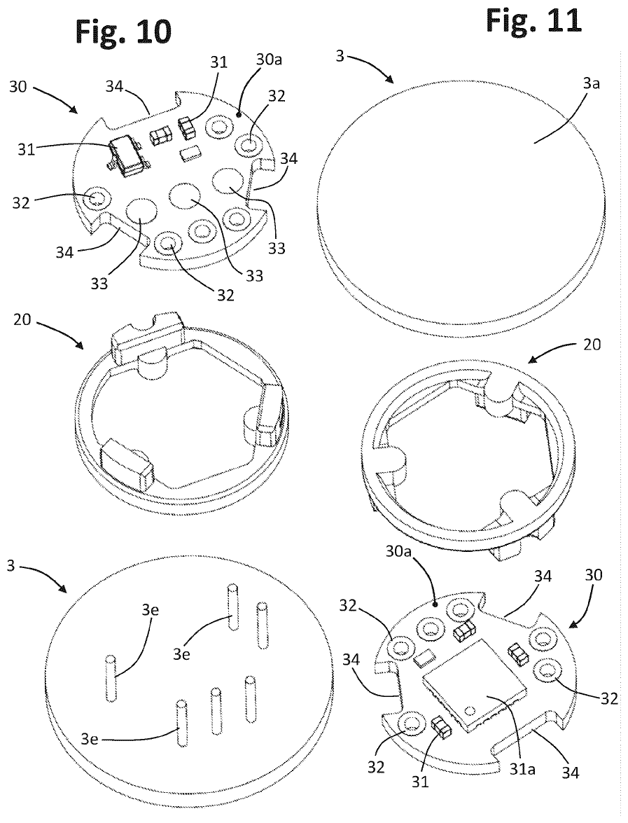

FIGS. 10 and 11 show a possible realization of the detection unit 10, including the sensitive element 3, the positioning body 20 and the control circuit 30. The latter comprises a printed circuit support (or board of PCB-Printed Circuit Board) 30a made of electrically insulating material, or rendered electrically insulating for example by the deposition of an insulating layer, on which there are deposited tracks of electrically conductive material, not highlighted, for the connection of electrical and electronic components 31 which are part of the control circuit 30 of the sensor device, according to a technique in itself known; the cited components preferably include an integrated circuit or the like 31a, such as a microcontroller or an ASIC (Application Specific Integrated Circuit) and/or memory means. The circuit support 30a has through holes, provided with an electrically conductive coating 32 to which some of the aforementioned tracks are connected; the coatings 32 can comprise a surface metallization of the holes, shaped to define corresponding pads on at least one of the two opposite faces of the board 30a, to which are connected some of the aforementioned conductive tracks. In the mentioned holes there are inserted the pins 3e of the sensitive element 3 (see for example FIGS. 8-9), which are electrically and mechanically connected-for example by welding or tinning-to the coatings or pads 32.

In various preferential embodiments, on one face of the circuit support 30a, here referred to as the upper face, contact pads 33 are provided, to which some of the aforementioned conductive tracks are connected, intended for connection with the contact elements 11, as explained below.

In various embodiments, the positioning body 20 and the circuit support 30a have respective coupling elements, configured for identifying a mounting position of circuit support 30a on the positioning body 20. In the case exemplified in the figures, the circuit support 30a has peripheral seats or recesses 34 for this purpose, preferably radial seats or recesses. In the example shown, where the circuit support 30a has a substantially circular peripheral profile, there are three radial recesses 34 substantially at 120° from each other. The circular shape of the circuit support is not an essential feature.

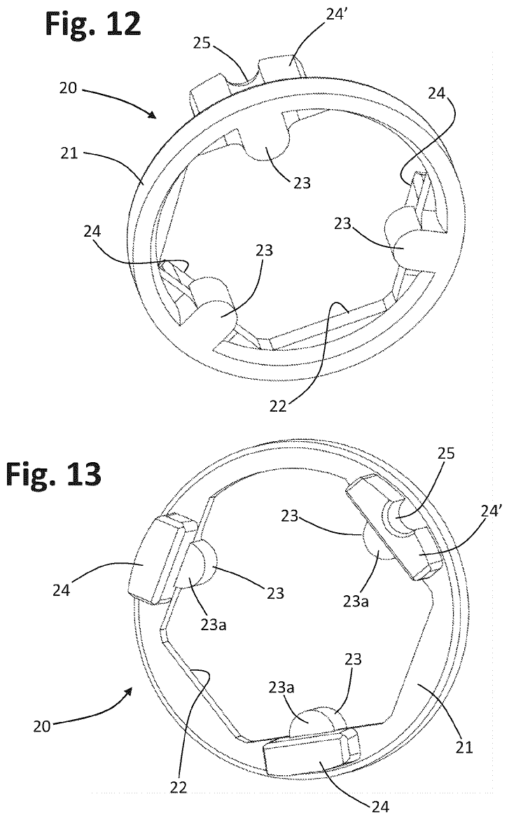

The positioning body 20 is shown in isolation in FIGS. 12 and 13. In this example, the general peripheral profile of the body 20 is substantially circular, in accordance with the peripheral profiles of the sensitive element 3 and the circuit support 30a. However, in other embodiments, the above profiles may be different from those exemplified, for example substantially quadrangular (square or rectangular) or polygonal with more than four sides (for example hexagonal).

The body 20 is preferably made of electrically insulating material, such as a moulded plastic material, and has an annular peripheral wall 21, defining a central passage 22, for example having a substantially polygonal shape or with a profile obtained by linear and/or curved stretches.

The body 20 defines support elements 23 for the circuit support 30, here consisting of radial protrusions of the inner side of the peripheral wall 21, that is, radial protrusions on the wall of the central passage 22; the protrusion 23 obtains first positioning means, in order to identify an axial position between the two parts in question, and have an upper surface 23a which identifies a support plane for the circuit support 30a. The body 20 has, preferably at its upper face, second positioning elements, preferably in the form of axial protrusions 24 which, as will be seen, obtains elements for coupling with the circuit support 30a, in order to identify a reciprocal angular position between the two parts in question.

In various preferential embodiments, the positioning body 20 and the distal end portion 5b of the engaging part 4 have respective couplabe elements, configured for identifying a unique mounting position of the detection unit 10 with respect to said distal end portion 5b. In the example shown, at one of the axial protrusions of the body 20 (designated by 24′ in the figures) a seat or recess 25 is defined, intended for coupling with a corresponding positioning element 13 (see for example FIG. 6), defined at the aforementioned distal end portion 5b, particularly within the housing C′.

The radial projections 23 are preferably in a position corresponding to that of the radial protrusions 24, but may be different in number and/or position and/or shape.

For the purpose of obtaining the unit 10, the control circuit 30, or the support 30a, is arranged on the positioning body 20, so that the positioning recesses 34 of the former are coupled with the positioning protrusions 24 of the latter, as shown for example in FIG. 8. Of course, the coupling means exemplified here by the protrusions 24 and the recesses 34 may be of a different type or shape.

The circuit support 30a is positioned so that its face bearing the contact pads 33 (FIG. 10) faces upwards. Subsequently, the lower face of the positioning body 20, shown in FIG. 12, is placed on the upper face of the sensitive element 3, from which the pins 3e protrude, which are passing through the central passage 22 of the body 20 (FIGS. 12-13), and can thus be inserted into the corresponding holes provided with the conductive coating 32 on the support 30a.

The pins 3e are then welded or otherwise fixed (for example by means of a paste or an electrically conductive glue) with respect to the coatings or pads 32, in order to obtain the electrical and mechanical connection between the circuit 30 and the sensitive element 3. Thus, the circuit support 30a is mounted on the positioning body 20, which is in turn supported by the sensitive element 3, with the electrical connecting elements represented by the pins 3e which constrain said support 30a to the sensitive element 3, with the body 20 interposed, forming the detection unit 10. Thus, preferably, the sensitive element 3 indirectly supports the circuit 30, via the body 20.

It will be appreciated that, in this way, the unit 10 obtains an assembly that can be pre-assembled and that can be easily manipulated in the production phase, possibly already equipped with the sealing element 12, with clear advantages, for example in terms of automated production and/or handling and warehouse management of pre-assembled parts, for subsequent production, also in the form of different types of final pressure sensor. Note that the connecting elements, i.e., the pins 3e, could be replaced by surface-mounted terminals (surface-mount technology) on the upper face of the substrate 3b of the sensitive element 3, which are then electrically connected (e.g., by tinning) to the circuit holder 30a, in a way similar to the pins 3e.

Another possibility consists in replacing the pins 3e with connection pads on the upper face of the substrate 3b, and obtaining the connection between these pads and homologous pads on the circuit support 30a by means of elastic contact elements (for example of the type designated by 11); in this case, the aforementioned elastic contact elements can have a first end thereof welded with surface-mount technique to the pads on the upper face of the substrate 3b, and tinned at the opposite end thereof to the corresponding pads of the circuit support 30a.

It will be appreciated-for example from FIGS. 8, 10-11 and 15-that in the assembled condition of the unit 10, the circuit support 30a extends substantially parallel to the sensitive element 3, or the membrane 3a thereof. From the same figures it can be seen how, preferably, the circuit support 30a has a sectional area (i.e., lateral overall dimensions) that is smaller than the sensitive element 30; Preferably, the positioning body 20 also has a sectional area (i.e. lateral overall dimensions) that is smaller than the sensitive element 30. Also as a preferential measure, the circuit support 30a and/or the positioning body 20 and/or the sensitive element 30 has/have a sectional area (i.e., lateral overall dimensions) that are not greater than the sectional area of the distal end portion 5b.

The distal end portion 5b of the engaging part 4 of the supporting body 2 is preferably shaped to house inside a portion of the detection unit 10, particularly a portion that includes at least part of the circuit support 30a and/or the positioning body 20.

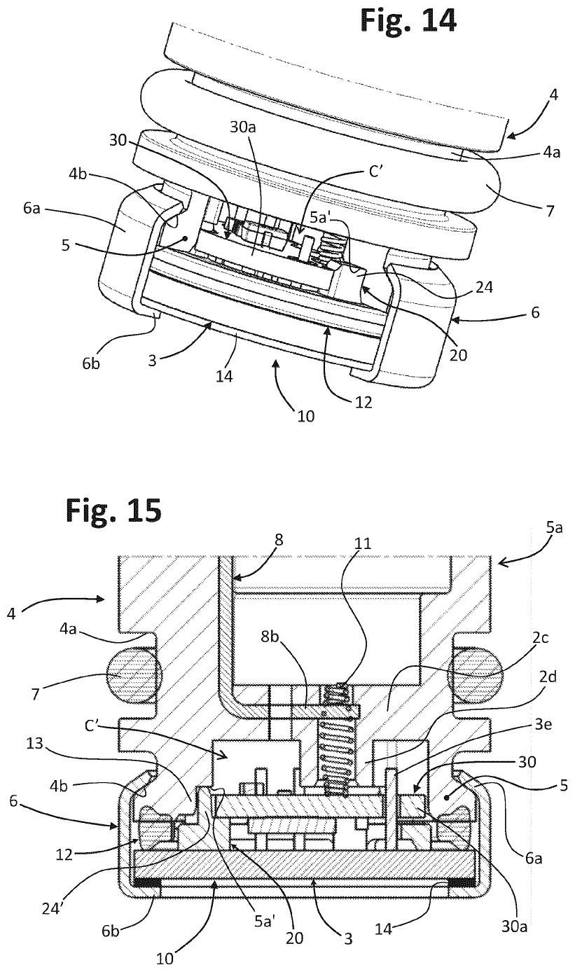

As already indicated, in various preferential embodiments, the distal end portion 5b defines a housing C′ (see also FIG. 6), wherein the detection unit 10 is at least partially received. FIGS. 14 and 15 show that, in the assembled condition of the sensor device, part of the positioning body 20 and the circuit support 30a are within the housing C′.

Preferably, the distal end portion 5b, particularly within the cavity C′, also defines one or more axial resting or positioning surfaces for at least one of the positioning body 20 and the sensitive element 3. In the example shown in FIGS. 14-15, 5a′ designates an axial positioning surface with respect to which the top of the axial elements 24 and 24′ (see also FIGS. 8 and 13) can be abuts against (note that, for example, in view of the elastic mounting, the axial elements 24 could abut against the surface 5a′ only as a result of external stresses).

Preferably, within housing C′ also open the seats for the contact elements 11 defined in the formation 2d of the wall 2c, as can be seen in FIG. 15.

In various embodiments, the detection unit 10 and the distal end portion 5b of the engaging part are configured in such a way that said unit 10 can be mounted from the bottom (with reference to the figures) relative to said portion 5b, from outside it. Such a solution allows, for example, to simplify the assembly of the device.

FIGS. 14 and 15 are intended to exemplify a first possible way of mounting the pre-assembled detection unit 10, which uses the fixing element previously indicated by 6. As also shown in FIG. 5, in this embodiment the fixing element 6 has an annular or tubular body having a peripheral wall 6a that has, at the lower end, a flange 6b radially protruding inwards, to define a passage 6c having a diameter, or a sectional size, which is smaller than the maximum diameter or sectional size of the sensitive element 3, so basically obtaining a support for the sensitive element 3, or for the pre-assembled detection unit 10.

The elastic contact elements 11 are mounted in the relevant seats (see also FIG. 6), so as to be in compression contact against the distal end portions 8b of the corresponding terminals 8; these portions 8b of the terminals could have holes or positioning reliefs for the upper end of the elements 11, in a position corresponding to the seats for the elements 11 (in the example, since the contact elements are essentially in the form of a helical spring, their upper end is depicted in the original extended form, to give an idea of how this end will be elastically compressed during assembly, to abut against the portion 8b—see FIG. 15). The pre-assembled unit 10, externally provided with the sealing element 12, is then leaned against the lower end of portion 5b of the engaging part 4, from the bottom, so that at least part of the unit 10 (here the circuit support 30a and preferably part of the positioning body 20) extends into the housing C′; As mentioned, the univocal positioning of the unit 10 is guaranteed by the coupling means consisting of the seat 25 of the body 20 and the corresponding element 13 of the distal end portion 5b. This positioning ensures that the lower end of the contact elements 11 is electrically in contact with the corresponding pads 33 (FIG. 10) of the circuit support 30a. In this assembling condition, the upper part of the sealing element 12 rests on the end flat surface of the distal portion 5b (as mentioned, for example in FIG. 4 and in the corresponding detail of FIG. 15, the sealing element 12 is shown in its condition not elastically compressed).

The annular fixing element 6 is then put from below on the distal end portion 5b provided with the detection unit 10. In various preferential embodiments, compensation and/or sealing means are provided between the fixing element 6 and the sensitive element 3, particularly designed to achieve an axial compensation and/or a sealing with respect to a peripheral annular portion of the membrane of the sensitive element 3. In the exemplified case, a compensation and/or sealing ring 14 is provided for this purpose (see also FIG. 5), preferably a flat annular element, for example in Teflon, which is inserted preliminarily into the element 6 and which stands on the flange 6b.

Note that element 14 may be absent, or replaced by a technically equivalent element, as tightness is in any case guaranteed by the element 12. The presence of the element 14 may be advisable to avoid possible damages to the membrane 3a due to a direct coupling with the metal of the tubular element 6 (for example during its deformation, or as a result of possible thermal expansions).

The peripheral wall 6a of the fixing element 6 surrounds the sensitive element 3 and surrounds at least one portion of the distal end portion 5b. This peripheral wall 6a is then fixed to the distal end portion 5b, so that the flange 6b of the element 6 holds the detection unit 10 in position with respect to the distal end portion 5b, with the sealing element 14 set therebetween, as shown in FIG. 15.

For the purpose of fixing, in various embodiments, the engaging part 4 externally defines a seat 4b, at which a corresponding upper portion of the peripheral wall 6a of the element 6 is coupled. In various embodiments, the element 6 is made of metallic material, and fastening relative to the seat 4b is done by mechanical deformation, for example clinching or rolling; for this purpose, the seat 4b preferably has a surface generally flared upwards. Preferably, the operation of fixing the element 6 takes place while obtaining a slight compression of the element 14, in order to obtain or improve its tightness or elastic compensation function. As can be seen in FIG. 15, following fixing of the element 6, the sealing element 12 operates a predominantly axial seal between the upper surface of the sensitive element 3 and the aforementioned end flat surface of the portion 5b. On the other hand, the ring 14 can possibly also achieve an essentially axial seal between the flange 6b of the element 6 and the peripheral part of the membrane (not highlighted in FIG. 15) of the sensitive element 3, preventing possible infiltration of the fluid in this area. It will be appreciated that, due to the presence of the elements 12 and/or 14, the mounting of the unit 10 is essentially an elastic one. The use of elastic contact elements 11 also contributes to this elastic mounting.

The aforementioned elastic-type mounting, in addition to ensuring the seal, allows for compensating for possible mechanical stresses that could cause damage to the sensor, such as vibrations during use and/or mechanical stresses due to the mounting operations of the sensor in the user apparatus, these risks being greater in the case of a sensitive element located on the distal end of an engaging part that must be inserted into a duct. The elastic mounting allows, if necessary, to compensate also possible different thermal expansions of the parts involved, which could be more accentuated in the distal end area of the engaging part, when exposed directly to the fluid.

In the assembled condition, the upper end of one or more of the projections 24, 24′ of the positioning body may be abutted against the corresponding surface 5a′ of the distal end portion 5b (it might be also slightly spaced apart therefrom, to enable the aforementioned elastic mounting, in this case operating as a stop in the event of excessive stresses).

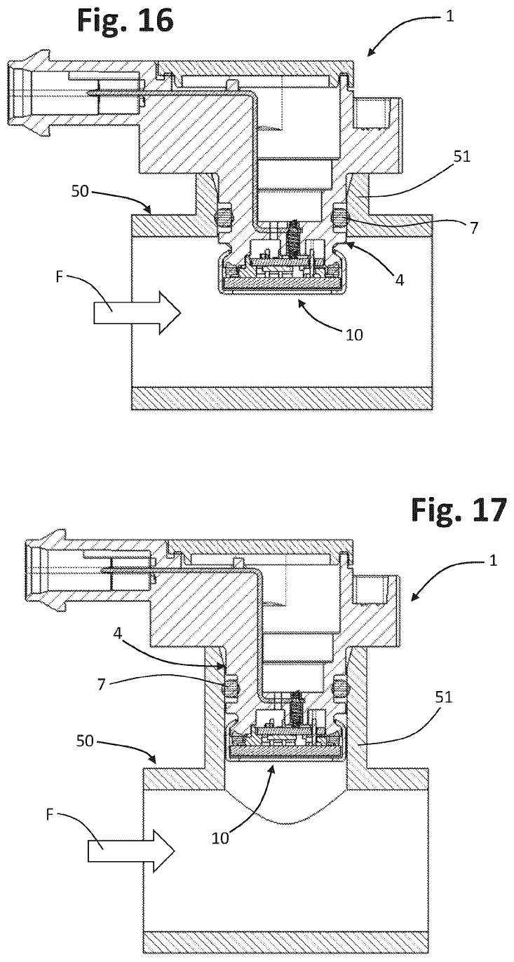

FIGS. 16 and 17 schematically illustrate two possible mounting configurations of device 1, for example in a duct of a user apparatus, such as a fuel cell system. In these figures, reference 50 designates a generic fluid duct F the pressure of which has to be detected, while reference 51 designates a lateral or radial tubular passage of the duct 50, for installation of the device 1.

In the case of FIG. 16, the tubular passage 51 has an axial development (length) which is smaller than the engaging part 4 of the device 1, but still such to receive the external sealing element 7. In this way, at least the distal end portion of part 4 with the associated detection unit 10 is protruding inside the duct 50. It will be appreciated that, in this configuration, the membrane of the sensitive element is exposed to a maximum extent to the fluid, except for its peripheral annular region (which is not however subject to deformation for detection purposes), which is covered and therefore protected by the flange 6b of the fixing element and by the possible compensation and/or sealing element 14. In such a configuration, the points of possible accumulation of moisture are absent, or in any case limited, such that that a possible icing does not affect the correct operation of the device 1.

FIG. 17 relates to a different mounting configuration, wherein the tubular passage 51 has an axial development (length) that is greater than the engaging part 4 of the device 1. In this case, the engaging part 4 with the associated detection unit 10 is in a recessed (not protruding) position with respect to the duct 50. Even in this configuration, however, the same effects indicated above are obtained, concerning the reduction of the points of possible accumulation of moisture present in the fluid F. The installation configurations of FIGS. 16 and 17 can also be used in the case of the variant embodiments described below. Note that, in the installation configurations of FIGS. 16 and 17, the sensitive element 3, or at least part of the detection unit 10, is protected with respect to tubular passage 51, in particular by the annular element 6.

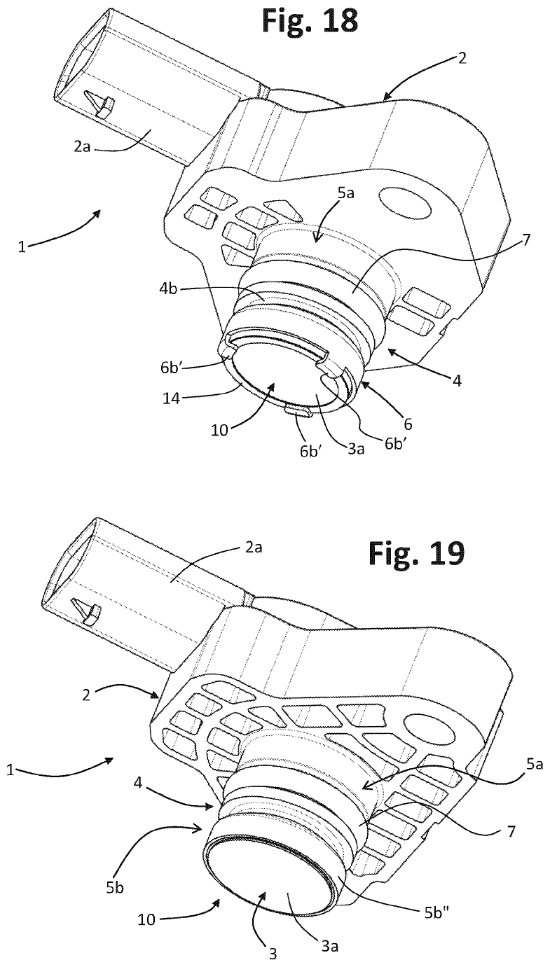

FIG. 18 shows a possible variant embodiment, wherein the flange 6b of the element 6 is replaced by a plurality of retaining elements 6b′ radially projecting inwards, that is, being essentially L-shaped, which nevertheless fulfil the function indicated above for said flange 6b. The small size of the retaining elements 6b′, that is, the presence of free spaces between these elements 6b′, reduces the areas of possible condensate stagnation at the membrane 3a, and consequently further reduces the risk of possible formation of ice on the membrane.

The fact that the unit 10 creates a pre-assembled and manipulable assembly on its own makes it possible to provide for various alternative configurations of the corresponding fixing means.

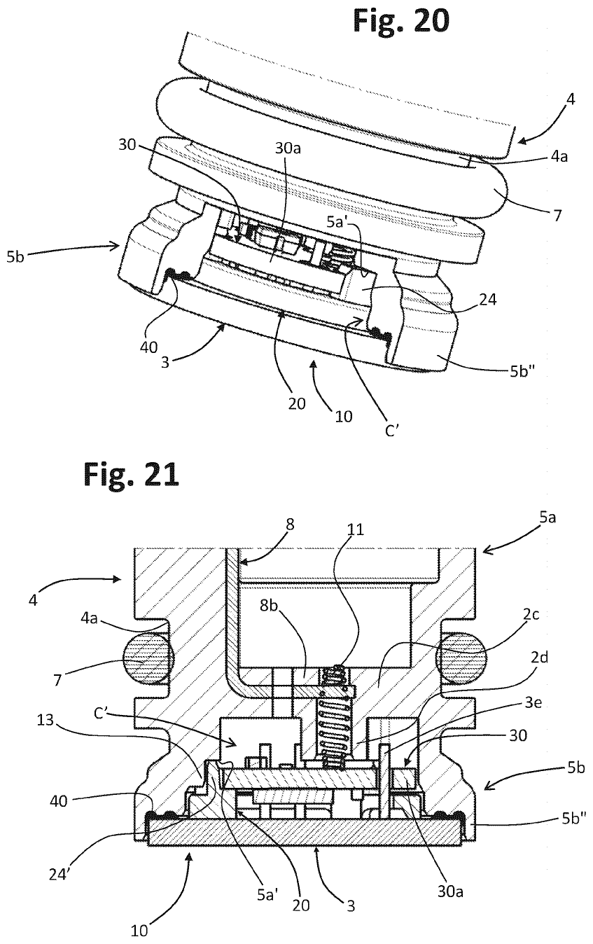

FIGS. 19-21 exemplify the case of a gluing of the unit 10 to the distal end portion 5b of the engaging part 4. As can be seen, particularly from FIGS. 20 and 21, many of the concepts already explained above also apply in this case, with the difference that, preferably, in this case the distal end portion 5b is configured so as to present a lower annular wall 5b″ or a tubular section, configured to at least partially surround also the sensitive element 3.

In this case, an annular layer of adhesive material 40 may be placed between relevant facing surfaces of the portion 5b and the sensitive element 3, to ensure both mechanical fixing and hermetic sealing. The elements 12 and 14 of the preceding figures are therefore not indispensable in this case. The fixing element or the unit 10 is represented here by the adhesive material 40.

In various embodiments, the adhesive material 40 is elastic, also creating a sealing element substantially similar from the functional point of view to that previously designated by 12, such as to allow, if necessary, an elastic compensation, or allow even minimal movements of the unit 10 with respect to the end portion 5b.

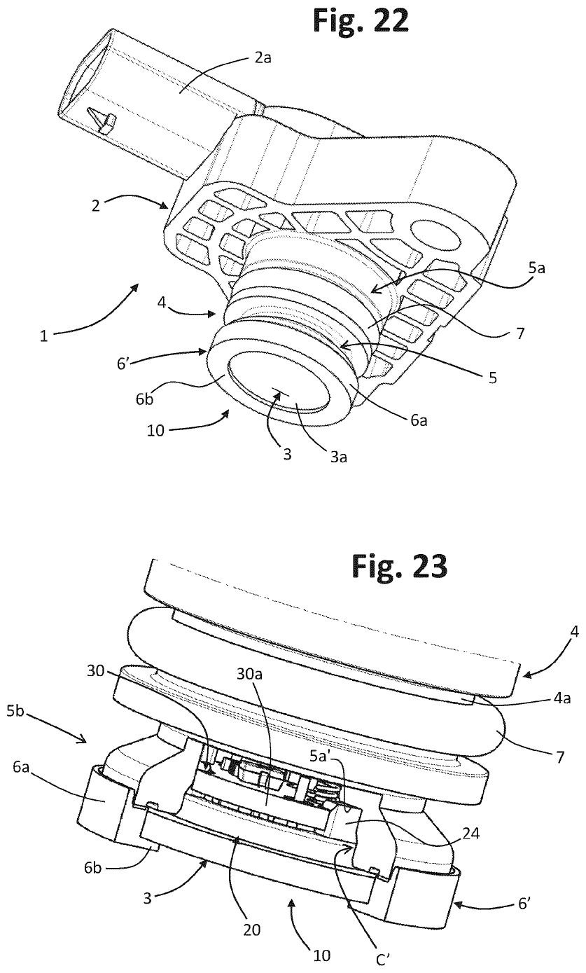

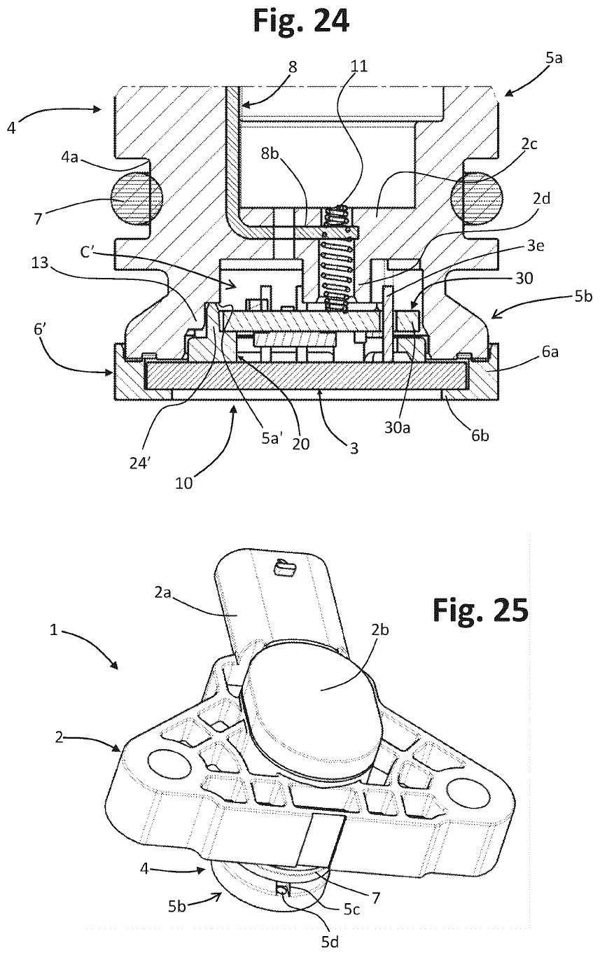

FIGS. 22-24 exemplify the case of fixing of the unit 10 to the distal end portion 5b of the engaging part 4 by means of a fixing element 6′ having a structure similar to that of the element 6 as previously described, and thus having an annular body with a peripheral wall 6a and a lower flange 6b radially projecting inwards. Also in this case the peripheral wall 6a is preferably shaped to encircle at least part of the unit 10, particularly at least its sensitive element 3, and part of the distal end portion 5b.

In the case exemplified, the engaging part 4 and the fixing element 6′ are formed with plastic material and are fixed together, preferably welded or glued, at facing surfaces of the part 4 and of the element 6, for example welded or glued along an annular fixing path, with the detection unit 10 interposed.

In this case, welding or gluing obtains the mechanical fixing element and at the same time guarantees hermetic sealing. Therefore, additional elements, such as those previously indicated by 12 and 14, are not necessarily required, but they may be present.

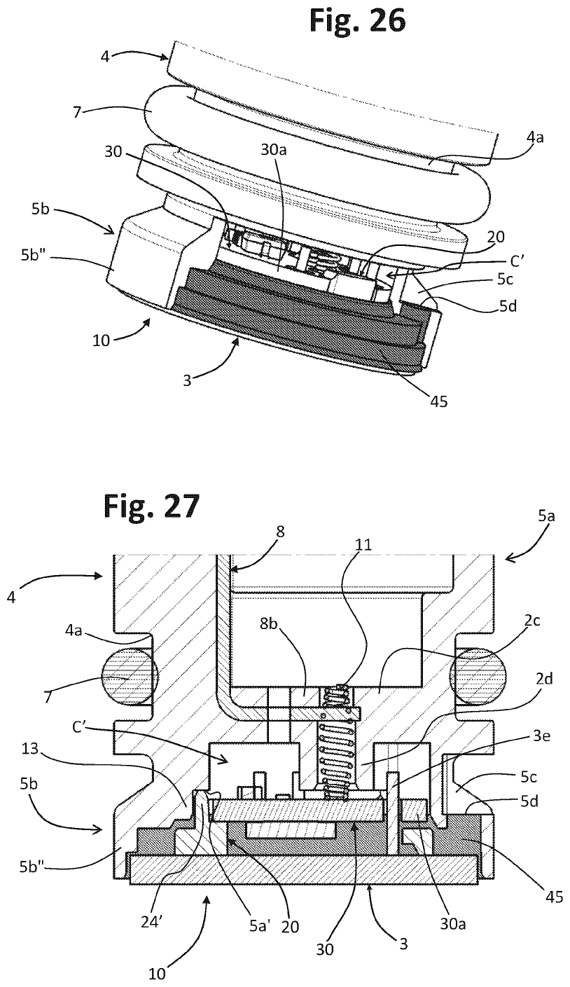

FIGS. 25-27 exemplify a further possible way of fixing the unit 10 to the distal end portion 5b of the engaging part 4, following an approach similar to that of the embodiment of FIGS. 19-21. Also in this case the distal end portion 5b includes a peripheral wall or lower tubular section 5b″ designed to surround at least part of the sensitive element 3. In addition, the portion 5b has externally an undercut 5c, at which a passage in fluid communication with the inside of the cavity C′ is defined.

After positioning of the unit 10 relative to the lower end of the portion 5b and the corresponding cavity C′, a mass of fixing material 45 is poured or injected into the cavity through the hole 5d, which mass obtains a fixing element, for example a sealing and gluing resin, electrically insulating, which fills gaps between the inner surface of the portion 5b, i.e., of the cavity C′, and part of the detection unit 10.

Preferably, the fixing material 45 is introduced in such a quantity that it creeps between the tubular section 5b″ and the peripheral surface of the sensitive element 3, and in such a way that at least part of the positioning body 20 and the circuit support 30a are englobed into this material 45, as can be seen, for example, in FIG. 27. Also in this case, polymerization of the material 45 guarantees both mechanical fixing and hermetic sealing, without the need for additional sealing elements.

In various embodiments, the pressure-sensitive element 3 can be equipped with sensor means for a detection of the temperature of the fluid F. Temperature detection can be useful-for example-for compensating the pressure measurements, or for performing corrective actions in the event that the fluid tends to assume potentially harmful temperatures (for example, in the event that an excessive lowering of the temperature is detected, which could potentially lead to an icing of possible accumulation of moisture, a heating element can be activated).

FIGS. 28-29 concern the case wherein a temperature sensor 60, for example a positive temperature coefficient (PTC) thermistor, is provided on the inner side of the membrane 3a. The sensor 60 can be advantageously realized obtained through a thick film deposition process, for example with screen printing technique, which is a technology that can also be used for the definition of the detection elements 3d of FIG. 9 and the corresponding conductive tracks, also these element being on the inner side of the membrane 3a. From FIG. 28 it can be seen that the thickness of the temperature sensor 60 is smaller than the height of the chamber 3f defined between the substrate 3b and the membrane 3a and, therefore, the temperature sensor does not hinder the elastic deformation of the membrane. In this case, on the inner side of the membrane 3a there will be conductive tracks for the transport of the signal from the sensor 60, connected to at least two of the pins 3e, in a manner known per se.

A realization of a temperature sensor 60 obtained with the indicated process is particularly convenient, given that the same process can be used both for obtaining the temperature sensor, and for obtaining the elements 3d (FIG. 9) responsible for detecting the deformation of the membrane, and is effective, as the sensor 60 is in direct contact with the membrane 3a, the outer side of which is in turn directly exposed to the fluid (see, for example, FIGS. 16-17). It should be noted in this regard that the membrane 3a is directly exposed to the flow of fluid and is directly invested by it; the membrane 3a is thin and is preferably formed with a material distinguished by good thermal conductivity (for example a ceramic material, such as alumina): in this way, the membrane 3a is able to quickly transmit the temperature change to the sensor 60, even if the latter is in a protected position on the inner side of the same membrane.

By the way, a temperature sensor may be obtained in different ways, for example as exemplified in FIGS. 30-31. Also in this solution the temperature sensor 60 is located on the inner side of the membrane 3a, but in this case it consists of a surface-mounted component (or SMD). In this case the thickness of the sensor 60 can be greater than the height of the chamber 3f, so that in the substrate 3b of the sensitive element 3, a space or recess 61 can be defined to enable housing of the upper part of the sensor 60, so as not to hinder the bending of the membrane 3a.

In various embodiments, the pressure-sensitive element 3 may be equipped with heating means, to prevent or eliminate possible icing on it of moisture residues, in the case of gaseous fluids, or of liquid, in the case of liquid fluids.

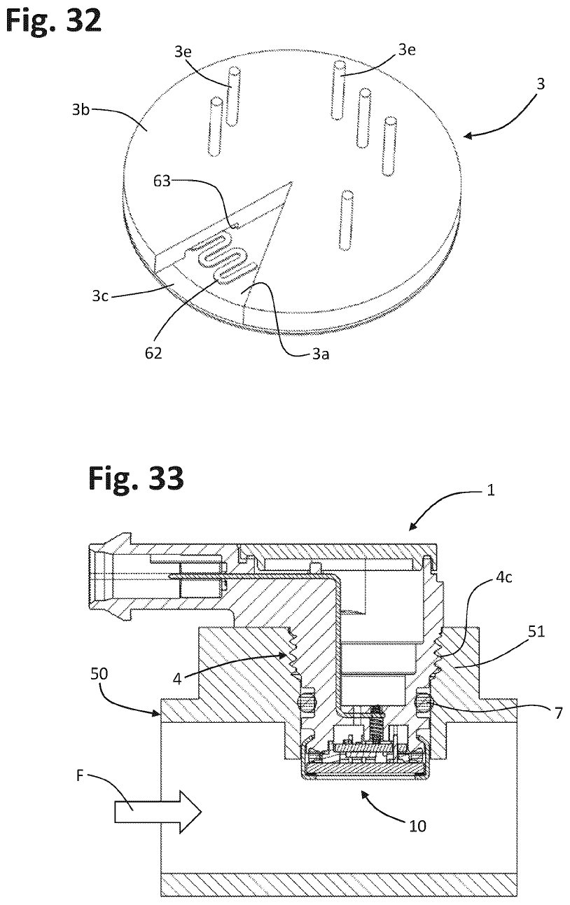

FIG. 32 illustrates the case where, on the inner side of membrane 3a, a heater 62 is provided, for example a screen-printed resistor. Also in this case, if necessary, the substrate 3b can be provided with a space or recess 63 aimed at allowing housing of the upper part of heater 62, so as not to hinder bending of the membrane 3a. Also in this case, on the inner side of the membrane 3a there will be provided conductive tracks for the supply of the heater 62, connected to at least two of the pins 3e. Also in this case the membrane 3a is thin and preferably formed with a material distinguished by good thermal conductivity (for example the aforementioned alumina), so that the membrane itself is able to quickly transmit the heat generated by means of the heater 62, and avoid or solve any icing problems. Operation of the heater 62 can be managed by the internal electronics of the device 1, or by the external electronics to which device 1 is interfaced via its connector (2a, 8).

As will be seen, in possible variant embodiments, the control circuit 30 could be obtained directly on the upper face of the substrate 3b, in which case the circuit support 30a and the body 20 might be not necessary.

The fixing of the device 1 to duct 50 (FIGS. 16 to 17) into which the fluid subject to detection flows may be attained using various fixing means, for example screws or similar threaded members, or by using a bayonet coupling, or by welding, or by a thread at at least part of the outer surface of the engaging part 4: this latter case is exemplified in FIG. 33, wherein the aforementioned thread is designated by 4C.

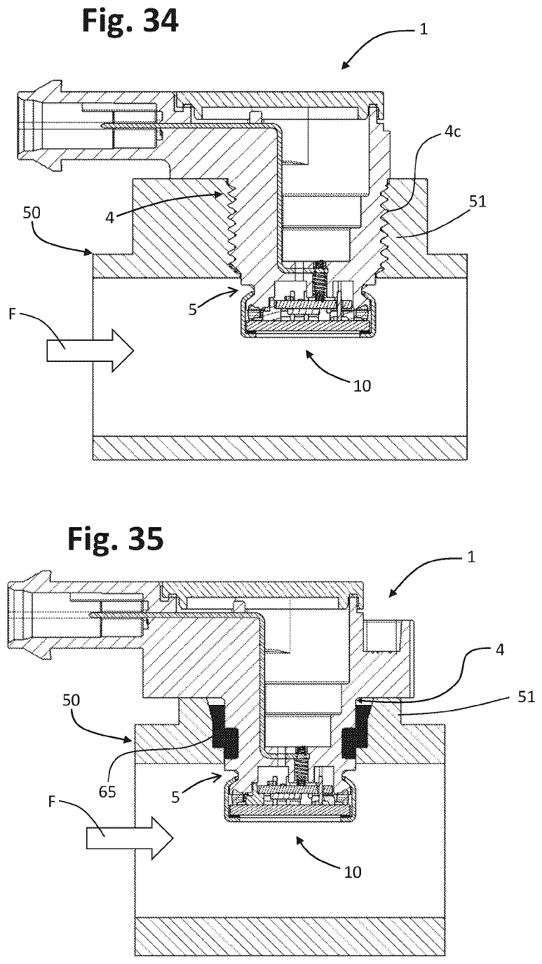

A threaded coupling of the type indicated can also be used to avoid the presence of the external sealing element 7, that is, with the same thread 4c that fulfills the function of a sealing element. For such a case, the thread 4c may extend to a greater extent on the outside of the engaging part 4, i.e., as far as the area from which the distal end portion 5b extends. Such a case is exemplified in FIG. 34. FIG. 35 schematically illustrates a further case of fixing, wherein the external sealing element 7 is not necessarily present. In this example, the body 2, i.e., its engaging part 4, is fixed relative to the passage 51 of the duct 50 by means of fixing means which comprise a fixing material 65, such as a resin. In such a case, the resin performs mechanical fastening functions and sealing functions. The external sealing element 7, when provided, can have a circular cross-section, as in the previous examples, or else have a quadrangular cross-section, or be a lip sealing ring. Irrespective of the design type, the sealing element 7 (or the means replacing it) is preferably in a position comprised between the two ends 5a and 5b of the engaging part 4, upstream of the detection unit 10 (and thus upstream of the sensitive element 3), as well as upstream of the means used to secure said unit 10 to the distal end portion 5b, with reference to the distal end portion 5b or the direction of insertion of the engaging part 4 into a corresponding passage, such as the passage 51 of a duct 50.

From the given description, the characteristics of the present invention are clear, as well as are its advantages.

The proposed solution is constructively simple, economical and reliable, thanks to the fact that the detection unit, which includes at least the pressure-sensitive element and the control electronics of the device, can be pre-assembled, particularly with the aid of a positioning body, and then easily and quickly mounted on the supporting body, even in a fully automated way. The preferential design which provides for the use of elastic contact elements further simplifies the assembly of the device, and reduces the possibility of stresses with respect to the detection unit. The mounting of the device in the working position is also simplified, given that the engaging part bearing the detection unit can simply be inserted into a corresponding passage, with the sensitive element that is in any case protected peripherally and not in contact with surfaces of said passage, without risks deriving from possible mechanical stresses on the detection unit.

It is clear that numerous variations are possible for the person skilled in the art to the pressure sensor device described as an example, without departing from the scope of the invention as defined by the claims that follow.

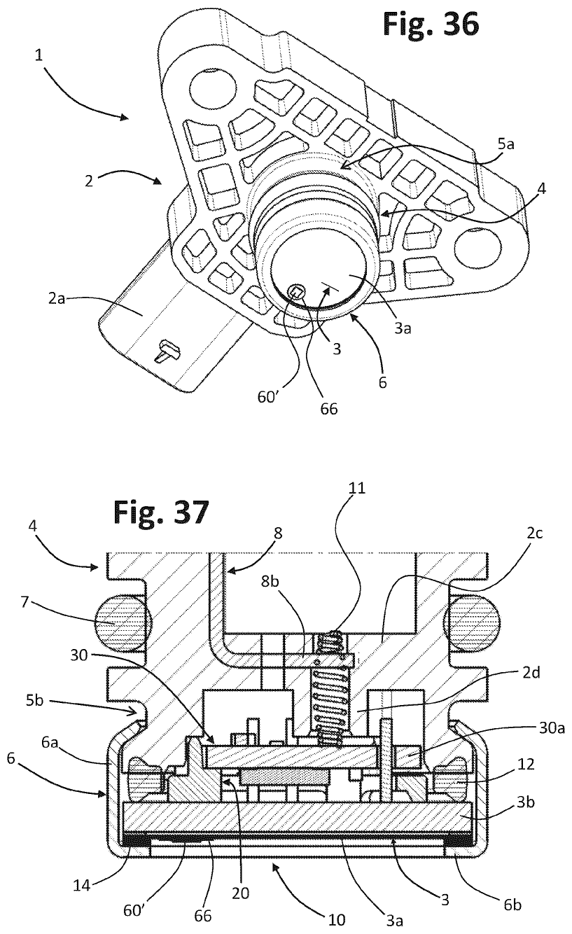

A surface-mount temperature sensor (or SMD) could possibly be provided on the outer side of the membrane 3a, with a possible protection layer (for example of a glassy type). Similarly, a temperature sensor, for example of a PTC-type, could be screen-printed on the outer side of the membrane 3a, with a corresponding protective layer (for example of a glassy type). Such a case is exemplified in a schematic form in FIGS. 36-38, wherein the abovementioned temperature sensor on the outer side of the membrane 3 is designated by 60′, and the abovementioned protective layer is designated by 66. In embodiments of this type, the sensitive element 3 will be provided with suitable connection elements in a known way (such as electrically conductive tracks and/or metallized holes) for the transport of the corresponding signal to two pin 3e. Cleary, a variant of this type can be used in all the embodiments described herein.

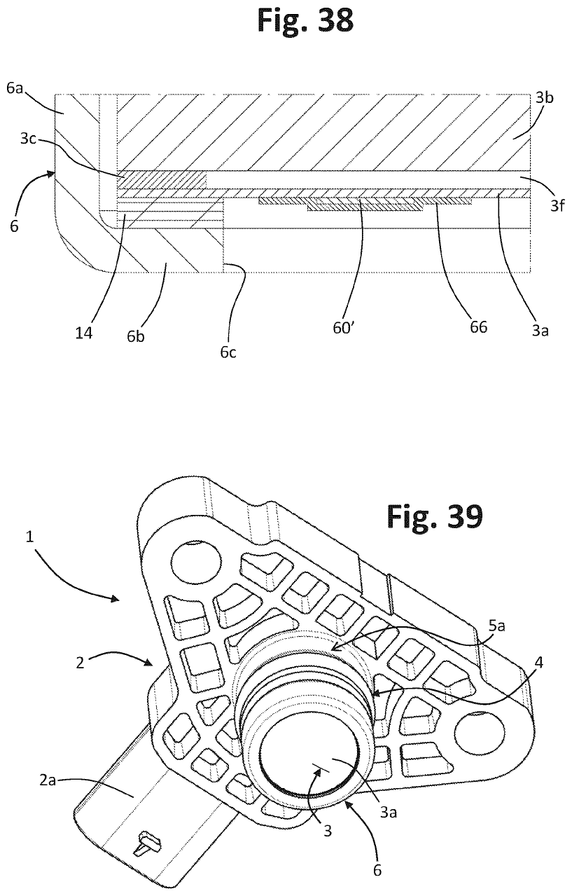

FIGS. 39-41 refer instead to the case of a sensitive element 3 wherein the membrane 3a has a smaller diameter (or sectional dimensions) than that of the corresponding substrate 3b, without prejudice to the fixing of the former to the latter, particularly by means of the material layer 3c, and with the annular sealing and/or compensation element 14 which is placed between the flange 6b of the element 6 and the annular region of the lower face of the substrate 3b which is radially external to the membrane 3a. In this case the membrane 3a preferably has a diameter (or sectional dimensions) smaller than that of the passage 6c defined by the same flange, although this is not an essential feature. Embodiments of this type can prevent possible assembly or mounting stresses, or thermal deformations, from being transferred to the membrane 3a.

As mentioned, the control circuit 30 could be obtained on the upper face of the substrate 3b of the sensitive element 3. In such embodiments, the functions of the circuit support 30a and the positioning body 20 previously described can be obtained by such a substrate 3b. In these embodiments, therefore, the pre-assembled detection unit comprises the sensitive element that directly supports the control circuit, i.e., without the mediation of the positioning body 20.

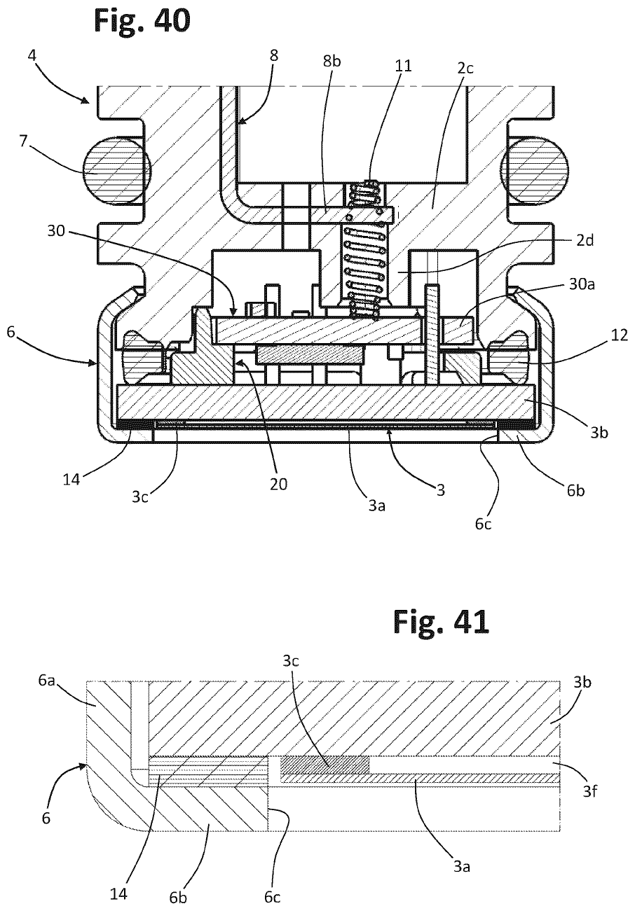

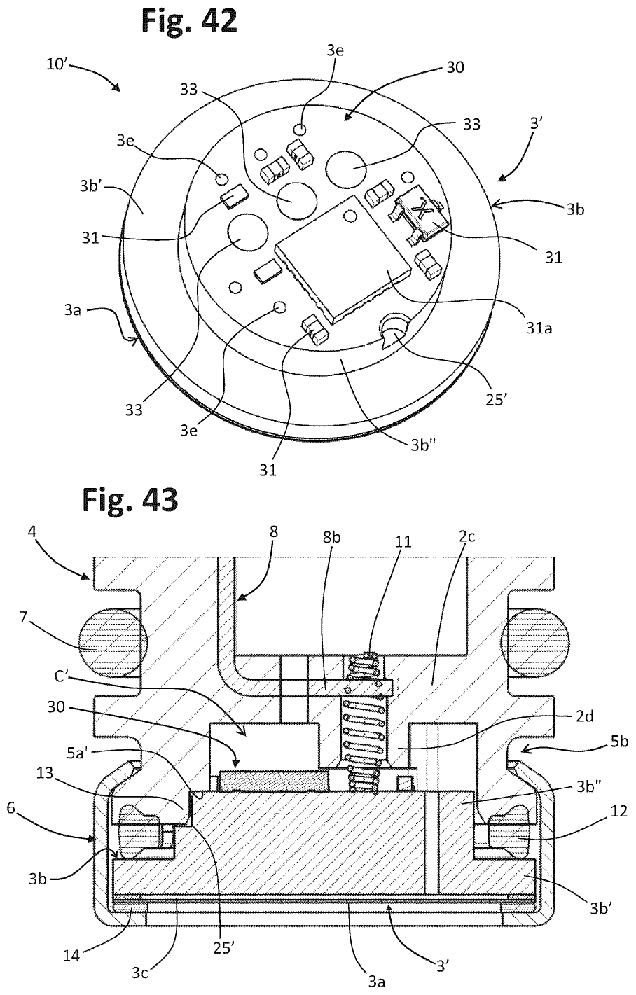

An example of this type is shown in FIGS. 42 and 43, wherein the detection unit is designated as a whole by 10′ and the sensitive element is designated as a whole by 3′. In such embodiments, the substrate 3b may include at least two different portions, and in particular an upper part having a diameter or sectional dimensions smaller than the diameter or sectional dimensions of a lower part. In the non-limiting example as shown, the substrate 3b comprises a lower part 3b′ having a diameter substantially similar to the diameter of the membrane 3a, and an upper part 3b″ of reduced diameter (without prejudice to the possibility of variants of the type shown in FIGS. 40-41).

On the upper surface of substrate 3b, here on the upper face of the portion 3b″, the control circuit 30 is obtained, with the corresponding elements—such as those previously designated by 31, 31a, 33—and the corresponding conductive connection tracks, not shown (as an alternative, the electronics or control circuit of the device may be partly on a circuit support 30 and partly on the upper face of the portion 3b″ of the substrate 3b). In this case, the upper part of the pins 3e of the sensitive element 3 protrudes only slightly from the substrate 3b and/or can be replaced by pads, from which corresponding conductive tracks of circuit 30 extend.

The upper portion 3b″ of the substrate is shaped to be at least partially housed within the cavity C′ of the distal end portion 5b, as well as allow positioning of the axial sealing element 12, as shown in FIG. 43. Moreover, the portion 3b″ can be configured so that one or more zones of its upper face can abut against one or more corresponding axial positioning surfaces 5a′, of the type already mentioned above.

Advantageously, the body of the substrate 3b, for example at the peripheral face of its upper portion 3b″, can also define the seat or recess (here indicated with 25′), for coupling with the corresponding element 13 of the distal end portion 5b, in order to identify the univocal positioning for the unit 10′.

Where required, a printed circuit board 30a for the circuit 30 could be in any way provided for the embodiments of FIGS. 42-43, for example glued or otherwise constrained on the upper face of the substrate 3′.

It will be appreciated that the concepts exemplified with reference to FIGS. 42-43 can be used also in all the embodiments described previously.

1. A pressure sensor device for a fluid, which comprises a supporting body and a detection arrangement associated to the supporting body,
wherein the detection arrangement comprises a pressure-sensitive element, having a detection membrane, and a circuit arrangement, which includes a control circuit having a printed circuit support, and electrical connecting elements which electrically connect the pressure-sensitive element to the printed circuit support,
wherein the pressure-sensitive element is associated to the supporting body in such a way that a substantial portion of the detection membrane is directly exposed to the outside of the supporting body, to be reached by the fluid,
wherein:
the supporting body has an engaging part having a distal end portion at which the pressure-sensitive element is constrained;
the printed circuit support is associated to a positioning body, which is associated to the pressure-sensitive element, with the electrical connecting elements which constrain the printed circuit support to the pressure sensitive element with the positioning body at least partially set therebetween, to form a detection unit,
and wherein the detection unit is fixed to the distal end portion of the engaging part by means of at least one fixing element.

2. The device according to claim 1, wherein the distal end portion of the engaging part is shaped to house internally at least one portion of the detection unit which includes at least part of the printed circuit support and/or of the positioning body.

3. The device according to claim 1, wherein the distal end portion of the engaging part defines one or more resting or axial positioning surfaces for at least one of the positioning body and the pressure-sensitive element.

4. The device according to claim 1, wherein the detection arrangement comprises electrical connection terminals, having respective end portions which extend within the engaging part, and wherein between the end portions of the electrical connection terminals and the printed circuit support elastic contact elements are interposed.

5. The device according to claim 1, wherein:
the at least one fixing element comprises an annular body having a peripheral wall which at least partially surrounds the pressure-sensitive element and which surrounds at least one section of the distal end portion of the engaging part,
the peripheral wall has, at the lower end thereof, one of a flange radially protruding inwards and a plurality of retaining elements radially protruding inwards, and
the peripheral wall is fixed to the distal end portion of the engaging part, so that the flange or the plurality of retaining elements hold the detection unit in position with respect to the distal end portion of the engaging part, with possible interposition of a compensation and/or sealing element.

6. The device according to claim 1, wherein the distal end portion of the engaging part is shaped to house internally a portion of the detection unit which also includes at least part of the pressure-sensitive element.

7. The device according to claim 6, wherein the distal end portion of the engaging part has a tubular section which surrounds at least in part a peripheral surface of the pressure-sensitive element.

8. The device according to claim 6, wherein a fixing material is set between at least one of a peripheral surface and an upper surface of the pressure-sensitive element and a corresponding surface of the distal end portion of the engaging part, the fixing material obtaining the at least one fixing element.

9. The device according to claim 1, wherein the engaging part is externally provided with sealing means.

10. The device according to claim 1, wherein the supporting body is provided with means for fixing in position.

11. The device according to claim 1, wherein the positioning body and the distal end portion of the engaging part have respective couplable elements configured for identifying a unique mounting position of the detection unit with respect to the distal end portion of the engaging part.

12. The device according to claim 1, wherein the positioning body and the printed circuit support have respective coupling elements, configured for identifying a mounting position of the printed circuit support on the positioning body.

13. The device according to claim 1, comprising at least one axial-sealing ring arranged between the distal end portion of the engaging part and the detection unit.

14. The device according to claim 1, wherein at least one of a temperature sensor and a heating resistor is associated to the detection membrane, and/or wherein the pressure-sensitive element comprises a substrate to which the detection membrane is fixed by means of a fixing material, with the circuit support and the positioning body that are obtained by said substrate.

15. A pressure sensor device for a fluid, comprising a supporting body and a detection arrangement associated to the supporting body,
where the detection arrangement comprises a pressure-sensitive element, having a detection membrane, and a circuit arrangement, which includes a control circuit and connecting elements for electrically connecting the pressure-sensitive element to the control circuit, wherein the pressure-sensitive element and/or the control circuit is/are configured for the fixing to a distal end portion of an engaging part of the supporting body, by means of a fixing and protecting element or by means of a shaping of the distal end portion wherein:
the pressure-sensitive element comprises a substrate to which the detection membrane is fixed via a fixing material, and
the control circuit is obtained on the upper surface of the substrate of the pressure-sensitive element and/or on a printed circuit support which is constrained on the upper surface of the substrate, to form a detection unit.

16. The device according to claim 1, wherein the engaging part is configured for insertion in a passage of a duct of the fluid.

17. The device according to claim 5, wherein:
the annular body of the at least one fixing element is made of metal material and the engaging part externally defines a seat at which a corresponding upper portion of the peripheral wall is coupled, or
the annular body of the at least one fixing element is made of plastic material and the peripheral wall is fixed or welded to a section of the distal end portion of the engaging part.

18. The device according to claim 9, wherein the sealing means are in a position of the engaging part which is upstream of the detection unit, or upstream of the at least one fixing element, with reference to the distal end portion of the engaging part.

19. The device according to claim 10, wherein the means for fixing are in a position of the engaging part which is upstream of the detection unit or upstream of the at least one fixing element, with reference to the distal end portion of the engaging part.

20. A pressure sensor device for a fluid, which comprises a supporting body and a detection arrangement associated to the supporting body,
wherein the detection arrangement comprises a pressure-sensitive element, having a detection membrane, and a circuit arrangement, which includes a control circuit and electrical connecting elements which electrically connect the pressure-sensitive element to the control circuit,
wherein the pressure-sensitive element is associated to the supporting body in such a way that a substantial portion of the detection membrane is directly exposed to the fluid to the outside of the supporting body,
wherein:
the supporting body has an engaging part, with a distal end portion configured for insertion in a passage of a duct of the fluid and at which the pressure-sensitive element is constrained;
the pressure sensitive element comprises a substrate to which the detection membrane is fixed by means of a fixing material, with the control circuit which is obtained on an upper face of the substrate or on a printed circuit support which is constrained on the upper face of the substrate, to form a detection unit;
the distal end portion of the engaging part define a housing; and
the detection unit is received at least partially in said housing and fixed to the distal end portion via at least one fixing element.
